(19) United States
(12) Patent Application Publication
(10) Pub. No.: US 2019/0316734 A1
(43) Pub. Date: Oct. 17, 2019

(54) Low Pressure Fuel Management and Delivery System for a Liquefied Natural Gas Rail Locomotive Tender

(71) Applicant: United States Department of Transportation, FRA, Washington, DC (US)

(72) Inventor: Phani Krishnaswamy Raj, Burlington, MA (US)

(21) Appl. No.: 15/950,487

(22) Filed: Apr. 11, 2018

(51) Int. Cl. F17C 7/02; B61C 17/02; F04B 15/08; F17C 13/04; F17C 3/00; B65D 88/74

(52) U.S. Cl. CPC F17C 7/02; B61C 17/02; F04B 15/08; F17C 13/04; F17C 3/00; B61D 5/04; F17C 2265/066; F17C 2221/033; F17C 2201/035; F17C 2270/0173; F17C 2203/0629; F17C 2223/0161; F17C 2250/0636; F04B 2015/081

(57) ABSTRACT

A low-pressure fuel management and delivery system 10 for a liquefied natural gas (LNG) rail tender is disclosed. The system provides a rail tender that is inherently safer in operation to known LNG rail tenders through its use of a double-hulled tank design 12, which lacks any penetration of the bottom surface of the first inner tank 16 by any portion of the fuel supply portion of the system 10; the lower pressure storage of the fuel 22 in the first inner tank 16; the inclusion of a gas return line 58 for directing fuel 22 trapped in the LNG flow lines 38, the heat exchanger 46, or the multistage gas compressor 52 to the vapor space 32 of the first inner tank 16 at safe pressures and temperatures; the lack of cryogenic pumps within the first inner tank 16 to drive the fuel supply portion of the system 10; and the location of all the flow controlling valves 40, 42, 50, and 56 in positions that afford them improved physical protection from potential damage due to vehicular collisions or other railroad accidents. During operation, the fuel management and delivery system 10 provides required fuel flow rates and temperatures to an associated locomotive through the use of hydrostatic pressure differences between the LNG fuel 22 and the vapor space 32 within first inner tank 16, as well as a heat exchanger 46 and a multi-stage compressor 52, which are preferably located external of the double-hulled fuel storage tank 12, but on the same rolling stock chassis 14.

### FIELD OF THE DISCLOSURE

The invention relates in general to a fuel management and delivery system. More particularly, the present invention relates to a fuel management and delivery system for a locomotive tender. More precisely, the invention relates to a liquefied natural gas fuel management and delivery system for a locomotive tender suitable for operating at low positive gage pressures or near-atmospheric pressures.

### BACKGROUND OF THE DISCLOSURE

While rail moves only sixteen percent of freight by weight in the United States, it is the second most used means of transportation for freight, and by far its most efficient mode of transportation. With the growing concerns of the environmental impacts due to the burning of fossil fuels and transportation sector occupying the second place on the list of industries that contribute the most to the United States' annual greenhouse gas emissions, railroads are seeking, legislators are demanding, and regulators have established requirements for more fuel efficient and environmentally-friendly locomotives to help move the nation's freight. One fuel source that can ameliorate some of these concerns is liquefied natural gas (LNG).

In addition, because of significantly increased production of and self-sufficiency in natural gas in the United States, the costs of natural gas and LNG per unit of energy are lower, almost by half, compared to unit energy costs of diesel and other petroleum based fuels. The cost advantage in using LNG as a locomotive fuel is an additional incentive for the rail industry, which in recent years has spent over $11 billion for locomotive (diesel) fuel cost annually.

When natural gas, in its gaseous condition at atmospheric pressure and temperature, is cooled to 111 Kelvin (−260 degrees Fahrenheit) it becomes a liquid (LNG) at atmospheric pressure. Because of this liquefaction, the volume of the gaseous phase is reduced by a factor of more than 600 to form the liquid resulting in a significant increase in energy density (energy per unit volume, at atmospheric pressure). Therefore, the liquid (LNG) can be carried efficiently in manageable volumes, in locomotive tenders, to provide the necessary energy to run a locomotive on natural gas.

While natural gas is a potential solution to many of the present problems related to the continued use of coal, diesel fuel, or other hydrocarbon based fuel sources, the carriage of LNG in tenders comes with its own challenges, not the least of which is safety. To supply the locomotive engine gaseous natural gas at an engine-desired temperature and pressure (normally above 278 K [40° F.] and above 7 barg [100 psig], respectively) from a tender, it is necessary to maintain a LNG flow through a heat exchanger located on the tender. In one design, the LNG tank on the tender is maintained at a significant pressure (about 8.3 barg [120 psig] to 9.7 barg [140 psig]) to sustain the LNG flow and to provide the desired gaseous pressure to the engine. The higher the tender tank pressure the greater is the potential hazard area, if LNG is released from the tender due to an accident. As a result, concerns have arisen about the safety of current higher tank pressure based operational and design standards used for LNG rail tenders and the systems used to delivery such fuel from the tender to the locomotive. Alternatively, LNG can be maintained inside the tank at a relatively low positive gage pressure and the LNG flow pressure can be boosted through the heat exchanger by providing an electrically operated cryogenic pump inside the tank. Fixing pump failures and maintenance of a pump submerged in a very cold (111 K [−260° F.]) liquid pose technical and cost challenges.

The invention is a fuel management and delivery system for use on a liquefied natural gas rail locomotive tender which is suitable for operation at a lower storage tank pressure, while satisfying the temperature and pressure requirements for maintaining the natural gas in a liquid state and still satisfying the load demand requirements of its associated locomotive.

### SUMMARY OF THE DISCLOSURE

An embodiment of the present invention provides a fuel management and delivery system that may supply liquefied natural gas (LNG) fuel from a rail tender to a locomotive at or near atmospheric pressures without requiring submerged, internal cryogenic pumps or penetration of the bottom of the tender's inner LNG tank.

A rail tender incorporating a low-pressure fuel management and delivery system for supplying liquefied natural gas according to one embodiment of the present invention includes a rolling stock base for supporting elements of the fuel management and delivery system and a double-hulled, pressurized LNG tank. The rolling stock base includes an upper support surface for carrying either a fully-integrated, partially-integrated, or removable double-hulled, pressurized LNG tank. The support surface of the rolling stock base may additionally house or have integrated into it various elements of the fuel management and delivery system.

The doubled-hulled, pressurized LNG tank includes a first inner tank and a second outer tank. The first inner tank is generally made of stainless steel, but can be made of any other material suitable to maintain the liquefied natural gas at temperatures at or below 111 K (−260° F.), while ensuring the required structural rigidity and strength needed for safe operation. The second outer tank is generally constructed of carbon steel to provide a protective envelope for the first inner tank and to maintain a near vacuum condition in the annular volume space between the inner and outer tanks. In addition, the purpose of the outer tank is to provide additional protection against damage to the inner tank in the event of an accident that would otherwise damage the first inner tank. The annular space between the first inner tank and the second outer tank is maintained at or near vacuum and filled with insulative materials for maintaining the first inner tank at or below a desired temperature. Further, the annular space may include various elements of the fuel management and delivery system.

In operation, the liquefied natural gas is fed from the cryogenically-maintained first inner LNG fuel tank via an insulated pipe to a heat exchanger located outside the double-hulled, pressurized LNG fuel tank. The heat exchanger vaporizes the liquefied natural gas at low gage pressures. The vaporized liquefied natural gas may then be fed to a gas compressor to raise its pressure in accordance with the operational needs of the locomotive. In an alternative embodiment of the invention (not shown), a liquid compressor (instead of a gas compressor) may be located on the rolling stock, external to the tanks and before the heat exchanger in the LNG flow path to boost the liquid pressure to that desired by the locomotive engine and to vaporize the higher-pressure liquid in the heat exchanger. The higher-pressure vaporized liquefied natural gas is then fed to the locomotive via a flexible hose across the coupler between locomotive engine and the LNG fuel rail tender.

Additional advantages of the disclosure are set forth in, or will be apparent to those of ordinary skill in the art, from the detailed description as follows. It should also be appreciated that modifications and variations to the specifically illustrated and discussed features and materials hereof may be practiced in various embodiments and uses of this disclosure without departing from the spirit and scope thereof. Such variations may include, but are not limited to, substitutions of equivalent individual elements, means, features, and materials for those shown or discussed, and the functional or positional reversal of various parts, features or the like.

Still further, it is to be understood that different embodiments of this disclosure may include various combinations or configurations of presently disclosed features, elements, or their equivalents (including combinations of features or configurations not expressly shown in the figures or stated in the detailed description).

These and other features, aspects and advantages of the present disclosure will become better understood with reference to the following description and appended claims. The accompanying drawings, which are incorporated in and constitute a part of this specification, illustrate at least one embodiment and, together with the descriptions, serve to explain the principles of the disclosure.

### BRIEF DESCRIPTION OF THE DRAWINGS

A full and enabling disclosure, directed to one of ordinary skill in the art, is set forth in this specification, which makes reference to the appended figures, in which:

FIG. 1 is a conceptual view of one embodiment of the invention showing a system for delivering liquefied natural gas fuel; and

FIG. 2 is a sectional view illustrating a rail tender including a liquefied natural gas storage tank and a system for delivering liquefied natural gas fuel according to an embodiment of the present invention.

Repeated use of reference characters throughout the present specification and appended drawings is intended to represent the same or analogous features or elements of the present disclosure.

### DETAILED DESCRIPTION

Reference will now be made in detail to a presently preferred embodiment or embodiments of the disclosure, examples of which are fully represented in the accompanying drawings. Such examples are provided by way of explanation of the disclosure, not a limitation thereof It should be apparent to those of ordinary skill in the art that various modifications and variations can be made to the presently disclosed embodiments without departing from the spirit and scope thereof For instance, features illustrated or described as part of one embodiment may be used on another embodiment to yield a further embodiment. Still further, variations in selection of materials and/or characteristics may be practiced, to satisfy particular desired user criteria. Thus, it is intended that the present disclosure cover such modifications and variations as coming within the scope of the present features and their equivalents.

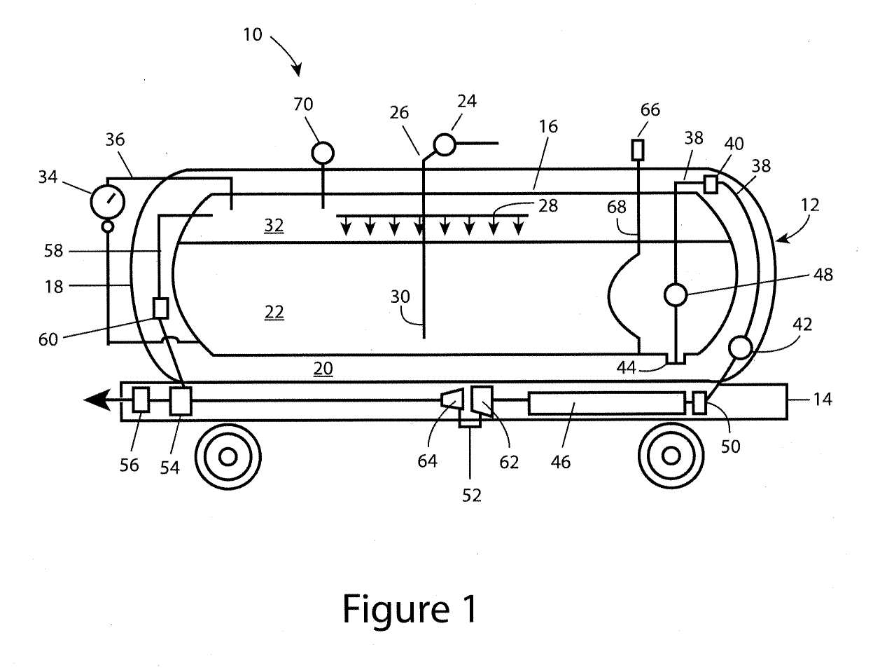

As disclosed above the present invention is particularly concerned with a LNG fuel management and delivery system for a rail tender. In one preferred embodiment of the invention as depicted in FIG. 1, a pressurized LNG rail tender 10 is provided. The LNG rail tender 10 includes a double-hulled tank 12 that rests on or may be fully- or partially-integrated into a rolling stock chassis 14. The rolling stock chassis 14 and double-hulled tank 12 maybe sized to fit any gauge rail tracks for operation, including standard American gauge tracks of 1435 mm (4 feet, 8.5 inches).

Double-hulled LNG fuel tank 12 is comprised of a first inner tank 16 and a second outer tank 18. The first inner tank 16 is a cryogenic tank intended to maintain the natural gas in a refrigerated liquid state for extended periods of time. The inner tank 16 may be made of stainless steel or any other suitable material sufficient to withstand the significantly lower operating temperatures to which it is exposed, while also providing sufficient structural integrity to serve as a pressure vessel for containing the LNG fuel 22.

The second outer tank 18 of the double-hulled LNG fuel tank 12 serves as a protective envelope for the first inner tank 16. Outer tank 18 may be made of carbon steel or other suitable material to maintain a vacuum in the annular space and to provide durability and protection to first inner tank 16 in the event of a collision or derailment of the rolling stock chassis 14.

The annular space 20 between first inner tank 16 and second outer tank 18 is preferably maintained in a vacuum to allow the inner and outer tanks 16 and 18 to work in coordination to significantly reduce the transmission of heat to the first inner tank 16. When in use, first inner tank 16 may be maintained between 0.1 Mpa and 0.27 Mpa absolute (0 and 25 psig), which corresponds to between 111 K and 125 K (−260 and 235° F.), in order to maintain the natural gas fuel 22 in a liquid state. To further assist in the prevention of heat transfer to the cryogenic liquid in first inner tank 16, the annular space between the first inner tank 16 and the second outer tank 18 may be filled with an insulative substance, including closed-cell foam and other known insulating materials.

Alternatively, the first inner tank 16 may be wrapped in several layers of thin insulation material of extremely low thermal conductivity. Additionally, component elements of the fuel management and delivery system may be run within the annular space between the first inner tank 16 and the second outer tank 18 to provide both insulative and physical protection to the system components.

In use, the first inner tank 16 is filled with LNG fuel 22 through a liquid fill line with a shut off valve 24 located along the top of the second outer tank 18. Fill shut off valve 24 is preferably a solenoid valve to allow for remote operation and the near-instantaneous termination of LNG fuel flow into the inner tank 16. Fill shut off valve 24 is in fluid communication with the first inner tank 16 via a fill pipe 26. Fill pipe 26 may be terminated within the first inner tank 16 by a sparging head 28, or a pipe 30 that allows the first inner tank 16 to fill from the bottom.

In this preferred embodiment of the invention, the fill pipe 26 penetrates only the upper surfaces of both the first inner tank 16 and the second outer tank 18. Fill operations are managed by on-board program logic controllers (not shown) and the flow control or shut off valve 24 in order to ensure the vapor space 32 of the first inner tank 16 is maintained at the desired pressure.

As filling operations for an LNG fuel tank 16 are generally performed using a closed-loop system—meaning any vapor displaced from the first inner tank 16 by LNG fuel 22 is recirculated to the vessel from which the LNG fuel 22 is provided—a means for determining the liquid fill level of the first inner tank 16 must be included. In this preferred embodiment of the invention, a differential pressure gauge 34 may be utilized to measure the hydrostatic head difference between the bottom of the liquid-filled first inner tank 16 and the vapor space 32 within first inner tank 16. Gauging line 36 at one end may penetrate near the bottom of first inner tank 16 in fluid communication with the LNG fuel 22. At its other end, after passing through differential pressure gauge 34, gauging line 36 may penetrate near the top of first inner tank 16 so as to be in fluid communication with the vapor space 32 inside the first inner tank 16. The markings on the differential pressure gage 34 may be calibrated to correspond to different liquid depths in the first inner tank 16. Such arrangement allows a fill operator to easily monitor the depth of liquid (and from it the volume of liquid in the first inner tank 16) at any time and to ensure that overfill of the first inner tank 16 does not occur.

In normal train operation, the fuel management and delivery system 10 serves to provide

LNG at the desired flow rate to the heat exchanger 46. The heat exchanger vaporizes the liquid into a gaseous phase at about the same pressure as of the liquid 22. Using only the pressure of the vapor space 32 in the first inner tank 16 and the hydrostatic pressure of liquid in the first inner tank 16, the system 10 pushes fuel 22 from the first inner tank 16 through LNG flow line 38 past both a safety shutoff valve 40 and through a flow rate control valve 42. Preferably, both control valves 40 and 42 are solenoid values providing an additional level of safety and LNG flow rate controllability; where in the event of a loss of electrical power the valves close automatically and terminate fluid flow to the associated locomotive.

First inner tank 16 has a sump 44. The flow of LNG fuel 20 begins within the sump 44 where the lower end of LNG flow line 38, preferably made of stainless steel, is submerged. Within the sump 44, the hydrostatic pressure differential between the LNG fuel 20 and the vapor space 32 is the greatest. When safety shut off valve 40 and flow rate control valve 42 are open, LNG fuel 20 will flow through LNG flow line 38 to heat exchanger 46. To ensure that no LNG fuel flows backward through the system, that portion of LNG flow line 38 within the first inner tank 16 may include a check valve 48.

Along its entire length, LNG flow line 38 is preferably located within the annular space 20 between the first inner tank 16 and the second outer tank 18 as best seen in FIG. 1. This placement serves to both further insulate the LNG flow line 38 from heat transfer from outside the second outer tank 18 and to take advantage of the physical security provided by the structural strength and rigidity of the second outer tank 18 in the event of an accident. Alternatively, LNG flow line 38 could run outside second outer tank 18, but it would need to be heavily insulated to ensure the LNG fuel 22 within the flow line 38 remained below its saturation temperature.

In this embodiment of the invention, before exiting LNG flow line 38 and entering the heat exchanger 46, the LNG fuel 22 passes through a manual flow shut off valve 50. Within the heat exchanger, the LNG fuel 22 may interact with an external heat source in any of the known methods of heat exchange. One such example is through the use of a closed loop of glycol (not shown) that may be heated by the locomotive's exhaust gas heat.

Once converted back into a gaseous form within the heat exchanger 46, the natural gas fuel 22 may be sent through a multistage compressor 52. The multistage compressor 52 may be designed and/or operated to ensure that the gaseous form fuel exiting the compressor 52 corresponds closely to the gas specification required by the locomotive for its use. Such gaseous fuel may be transported across the rail coupler to the associated locomotive using any known delivery method.

Any required modification to either the pressure or temperature of the gaseous form fuel exiting the compressor may be achieved by the use of a gas flow control valve 54 and a pressure throttle valve 56. As with the safety shut off valve 40 and the flow rate control valve 42, gas flow control valve 54 and pressure throttle valve 56 are preferably solenoid valves controlled by on-board program logic controllers (not shown). Additionally, as part of the system's inherent safety features, gas flow control valve 54 is a three-way valve connecting the high temperature, high pressure gaseous fuel flow to the fuel delivery line crossing the coupler to the associated locomotive or alternatively to gas return line 58.

In the event of a sudden decrease in the locomotive demand for fuel, in the presently preferred embodiment of the invention, the excess gas flow may be directed by gas flow control valve 54 to gas return line 58 for return to the first inner tank's vapor space 32. Along gas return line 58 is a pressure throttle valve 60 suitable to reduce the pressure of the gaseous fuel entering the first inner tank 16. In addition to the use of such gas pressure throttle valve 60, the present invention contemplates redirecting the gaseous fuel flow from the lower pressure initial stage(s) 62 of the multi-stage compressor 52 instead of either directly from the latter higher pressure stages 64 of the compressor 52 or via the gas flow control valve 54 in order to enhance safer operation of the system 10 during such situations. These alternative flow paths are not shown in the figures.

In the event of a complete termination of demand for fuel or an emergency requiring immediate gas flow shut off to the associated locomotive, the presently preferred embodiment of the invention provides for the on-board program logic controllers to close all solenoid flow control valves, including safety shut off valve 40, flow rate control valve 42, gas flow control valve 54, and pressure throttle valve 56. The higher-pressure gas fuel trapped between the exit of the multistage compressor 52 and the coupler may be directed through gas flow control valve 54 to gas return line 58 and ultimately back to the vapor space 32 within the first inner tank 16. The LNG remaining in the heat exchanger 46 may be allowed to slowly evaporate and the evaporated gas may be compressed by the first stage 62 of the multistage compressor 52 and may be directed to the vapor space 32 of the first inner tank 16 via the gas return line 58 and gas pressure throttle valve 60.

The presently preferred embodiment contemplates multiple methods for the emergency evacuation of LNG fuel 22 from the first inner tank 16. A first method is contemplated that works regardless of the orientation of the rail tender provided the first inner tank 16 is without damage or puncture to first inner tank 16. First, all program logic controlled solenoid flow control valves 40, 42, 54, and 56 are closed. Manual shut off valve 66 is opened. Valve 66 is in fluid communication with a flexible evacuation hose 68 that is longer than the internal diameter of the first inner tank 16 so that its end may always find the lowest point within the first inner tank 16, irrespective of the orientation of the first inner tank 16. To evacuate the LNG fuel 22 from the first inner tank 16, emergency tank pressurization valve 70 is opened and connected to a higher-pressure source of a non-flammable gas, such as nitrogen. When first inner tank 16 is pressurized, the remaining LNG fuel 22 will be forced through the flexible evacuation hose 68 past open manual shut off valve 66 to a connected alternative storage solution.

An alternative embodiment of the present invention envisions manual flow shut off valve 50 as a three-way valve. Such embodiment provides an alternative means for removing LNG fuel 22 from first inner tank 16, provided the rail tender is generally upright and lacks any damage or punctures. Using the hydrostatic pressure between the LNG fuel 22 and the vapor space 32, with safety shut off valve 40 and flow control valve 42 both open, the remaining LNG fuel 22 may be driven through LNG flow line 38 toward manual flow shut off valve 50. The evacuated LNG fuel 22 could be directed through manual flow shut off valve 50 to a connected alternative storage solution.

In yet another embodiment, emergency tank pressurization valve 70 could additionally serve as a bleed or venting valve allowing the release of boil off gas vapors in those situations requiring longer-term storage of LNG fuel 22 within the first inner tank 16. Such venting would be necessary only for storage over twenty one days or where the lower pressure operation of the first inner tank necessitates. Venting of such boil off vapors would allow the remaining LNG fuel 22 to self-refrigerate.

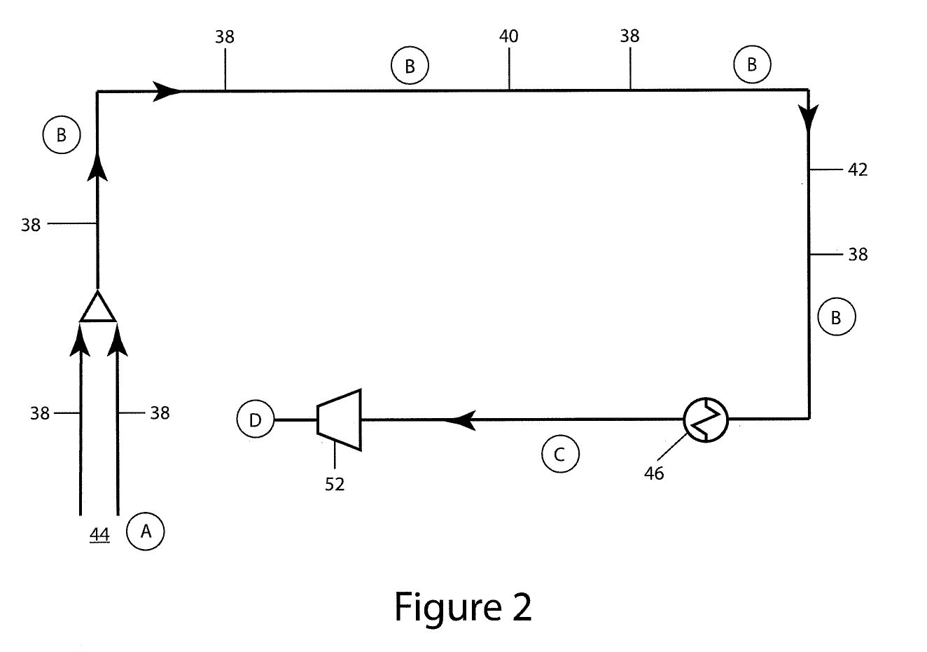

As best seen in FIG. 2, some exemplary pressure and temperature measurements at points along the fuel delivery portion of the management and delivery system 10 are provided for a LNG flow rate of 38 liters/min (10 gpm) through the heat exchanger 46 and valve 56. Within first inner tank 16 in sump 44 at location A, the head pressure of the LNG fuel 22 may be approximately 0.2 MPa absolute (14-15 psig) at an approximate temperature of 120.4 K (−243° F.). As the LNG fuel 22 passes through insulated LNG flow line 38, safety shut off valve 40, and flow rate control valve 42 at location B there is only a one to one and half degree Kelvin (two to three ° F.) increase in the temperature of the fuel 22. Similarly, the pressure drop along this path is only 0.014 MPa to 0.02 MPa (two to three psig).

Upon exiting the heat exchanger 46 at location C, having associated with the high temperature glycol flow heated by the associated locomotive's exhaust gases to approximately 322 K (120° F.), the temperature of the vapor produced by the fuel 22 rises to approximately 216 K (−71° F.) with a negligible pressure drop. Finally, as the now gaseous form natural gas fuel 22 passes through the multi-stage compressor, it exits at location D at a temperature of approximately 284 K (52° F.) and a pressure of approximately 1 Mpa (130 psig)—suitable for use by the associated locomotive.

Although a detailed description of at least one preferred embodiment of the present disclosure has been expressed using specific terms and devices, such description is for illustrative purposes only. The words used are words of description rather than of limitation. It is understood that changes and variations may be made by those of ordinary skill in the art without departing from the spirit or scope of the present disclosure, which is set forth in the following claims. Additionally, it should be understood that aspects of various other embodiments may be interchanged either in whole or in part. Therefore, the spirit and scope of the appended claims should not be limited to the detailed description contained herein.

What is claimed is:

1. A liquefied natural gas fuel management system for a railroad locomotive, said system comprising:
an insulated rail tank car secured to a rolling stock chassis, said insulated rail tank car suited to retain liquefied natural gas fuel;
wherein a fuel delivery system is located within said insulated rail tank car and said rolling stock chassis; and
wherein said fuel delivery system operates at gage pressures between 0.1 MPa absolute to 0.27 MPa absolute (0 and 25 psig).

2. The system of claim 1, wherein said insulated rail tank car is a double-hulled tank car.

3. The system of claim 2, wherein an annular space between said double-hulls of said tank car is held in at a vacuum pressure and filled with insulating material.

4. The system of claim 2, wherein said fuel delivery system comprises,
a liquid fuel flow line having a first end in fluid communication with said liquefied natural gas fuel inside said double-hulled tank car and a second end in fluid communication with a heat exchanger;
a safety shutoff valve, a fluid flow rate valve, and a manual shutoff valve, all in fluid communication with said liquid fuel flow line between said first end and said second end; and
a heat exchanger in fluid communication with said second end of said liquid fuel flow line, said heat exchanger suited to convert said liquefied natural gas to a gaseous form for use by said rail locomotive.

5. The system of claim 4, wherein said fuel delivery system further comprises,
a gaseous fuel flow line segment having a first end in fluid communication with said heat exchanger and a second end in fluid communication with said rail locomotive;
a compressor in fluid communication with said gaseous fuel flow line segment and located between said heat exchanger and said gaseous fuel flow line segment second end for increasing the pressure of the gaseous form natural gas for use by said rail locomotive.
a gas flow control valve in fluid communication with said gaseous fuel flow line segment between said compressor and said gaseous fuel flow line segment second end;
a pressure throttle valve in fluid communication with said gaseous fuel flow line segment between said compressor and said gaseous fuel flow line segment second end; and
wherein said gas flow control valve and said pressure throttle valve serve to modify the pressure or temperature of the gaseous form natural gas fuel as needed before it is supplied to the rail locomotive via said gaseous fuel flow line segment second end.

6. The system of claim 5, wherein said safety shutoff valve, fluid flow rate valve, gas flow control valve, and said pressure throttle valve are all solenoid valves.

7. The system of claim 5, wherein said compressor is a multistage compressor.

8. The system of claim 1, wherein said insulated rail tank car is filled using a differential pressure gauge measuring the hydrostatic head difference between the bottom of said insulated rail tank car and the vapor space within said insulated rail tank car to insure sufficient internal pressure for the system to function properly.

9. An integrated liquefied natural gas fuel management and delivery system for a railroad locomotive, said system comprising:
a double-hulled insulated rail tank car secured to a rolling stock chassis;
wherein a fuel delivery portion of said system is located between a first inner tank and a second outer tank of said double-hulled rail tank car and within said rolling stock chassis; and
wherein said integrated fuel management and delivery system operates at gage pressures between 0.1 MPa absolute to 0.27 MPa absolute (0 and 25 psig).

10. The integrated system of claim 9, wherein an annular space between said first inner tank and said second outer tank is held in at a vacuum pressure and filled with insulating material.

11. The integrated system of claim 10, wherein said first inner tank is a cryogenic tank and said second outer tank is a protective shell surrounding said first inner tank.

12. The integrated system of claim 10, wherein said first inner tank maintains liquefied natural gas between 0.1 MPa absolute to 0.27 MPa absolute (0 and 25 psig) and between 111 K and 125 K (−260° F. and −235° F.).

13. The integrated system of claim 12, wherein said fuel delivery portion of said integrated system comprises:
a liquid fuel flow line having a first end in fluid communication with said liquefied natural gas inside said first inner tank and a second end in fluid communication with a heat exchanger;
a safety shutoff valve, a fluid flow rate valve, and a manual shutoff valve, all in fluid communication with said liquid fuel flow line between said first end and said second end;
a heat exchanger in fluid communication with said second end of said liquid fuel flow line, said heat exchanger suited to convert said liquefied natural gas to a gaseous form for use by said rail locomotive; and
a compressor in fluid communication with said liquid fuel flow line and located before said heat exchanger with regard to the direction of fuel flow along said liquid fuel flow line, said compressor suited to increase the pressure of the liquefied natural gas prior to its passage into said heat exchanger.

14. The integrated system of claim 13, wherein said fuel flow line further comprises,
a gaseous fuel flow line segment having a first end in fluid communication with said heat exchanger and a second end in fluid communication with said rail locomotive;
a gas flow control valve in fluid communication with said gaseous fuel flow line segment between said compressor and said gaseous fuel flow line segment second end;
a pressure throttle valve in fluid communication with said gaseous fuel flow line segment between said compressor and said gaseous fuel flow line segment second end; and
wherein said gas flow control valve and said pressure throttle valve serve to modify the pressure or temperature of the gaseous form natural gas fuel as needed before it is supplied to the rail locomotive via said gaseous fuel flow line segment second end.

15. The integrated system of claim 14, wherein said safety shutoff valve, fluid flow rate valve, gas flow control valve, and said pressure throttle valve are all solenoid valves.

16. The integrated system of claim 15, wherein said compressor is a multistage compressor.

17. The integrated system of claim 9, wherein said system lacks any penetration of the bottom of said first inner tank.

18. An integrated liquefied natural gas fuel management and delivery system for use with a rail locomotive, wherein said system is capable of supplying said rail locomotive gaseous form natural gas at pressures and temperatures required for operation while retaining said liquefied natural gas between 0.1 MPa absolute to 0.27 MPa absolute (0 and 25 psig).

19. The integrated liquefied natural gas fuel management and delivery system of claim 18, wherein said system includes a gaseous fuel recovery system comprising:
a plurality of shutoff valves and a plurality of fuel flow control valves, including a gas flow control valve, in fluid communication with a fuel delivery line running from a liquefied natural gas fuel source to said rail locomotive;
wherein said plurality of fuel flow control valves serve to regulate the pressure of said fuel through said fuel delivery line to said rail locomotive; and
wherein said plurality of shutoff valves serve to terminate the flow of fuel to the rail locomotive in the event of a cessation of demand for fuel.

20. The integrated liquefied natural gas fuel management and delivery system of claim 19, wherein said three-way gas flow control valve, in the event of a termination of fuel demand from said rail locomotive, serves to redirect any fuel remaining in the fuel delivery line back to a vapor space within said liquefied natural gas fuel source at a pressure between 0.1 MPa absolute to 0.27 MPa absolute (0 and 25 psig).
